(19) United States
(12) Patent Application Publication
(10) Pub. No.: US 2008/0174127 A1
(43) Pub. Date: Jul. 24, 2008

(54) Opening and closing apparatus for mobile phones

(75) Inventors: Seong Geun Kim, Gyunggi-do (KR); Oh Soo Kwon, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/010,196

(22) Filed: Jan. 22, 2008

(30) Foreign Application Priority Data
Jan. 24, 2007 (KR) 10-2007-0007512

(51) Int. Cl. E05C 17/56

(52) U.S. Cl. 292/251.5

(57) ABSTRACT

Disclosed herein is an opening and closing apparatus for mobile phones. The apparatus includes an electromagnet which is installed at a predetermined position in a main body, with a permanent magnet being provided in the electromagnet. A metal piece is installed at a predetermined position in a display body, which is foldably coupled to the main body, and generates attractive force between the metal piece and the permanent magnet of the electromagnet. The electromagnet generates magnetic force to offset the attractive force between the permanent magnet and the metal piece when external electricity is applied to the electromagnet. The apparatus also includes a coil spring which elastically biases the display body to open the display body when external electricity is applied to the electromagnet.

### CROSS REFERENCE TO RELATED APPLICATION(S)

This application claims the benefit of Korean Patent Application No. 10-2007-0007512, filed on Jan. 24, 2007, entitled “opening and closing apparatus for mobile phones”, which is hereby incorporated by reference in its entirety into this application.

### BACKGROUND OF THE INVENTION

1. Field of the Invention

The present invention relates generally to an opening and closing apparatus for folding-type mobile phones and, more particularly, to an opening and closing apparatus for mobile phones, which is capable of automatically opening and closing a mobile phone using an electromagnet, the polarity of which is changed using external electricity.

2. Description of the Related Art

Mobile phones, which have been widely used in recent years, tend to have various functions, for example, a moving picture playing function and a gaming function, in addition to a voice service and a message service. In particular, since mobile phones, such as a DMB phone, which lets a user watch TV while traveling, have come onto the market, the demand for mobile phones that are small to allow a user to easily carry them and have large LCD screens to allow them to conveniently watch TV has increased. Therefore, research on mobile phones that are small and have large LCD screens has been actively conducted.

Generally, the mobile phones are classified into a folding-type mobile phone and a slide-up mobile phone. The folding-type mobile phone is designed such that a display body foldably opens and closes a main body. The slide-up mobile phone is designed such that a display body opens and closes a main body in a sliding manner.

Meanwhile, a conventional folding-type mobile phone is constructed so that a display body is opened and closed manually by a user. However, there is consumer demand for an automatic opening and closing apparatus for automatically opening and closing the display body. In order to satisfy this demand, Japanese Patent Laid-Open Publication No. Hei 8-97891 has been proposed. According to this document, a display body is automatically opened and closed using a spring and magnets. This is schematically shown in FIG. 5.

As shown in FIG. 5, the conventional opening and closing apparatus for mobile phones includes a first magnet 2a, a second magnet 3a, a coil spring 5, and a button 12. The opening and closing apparatus, constructed as such, is installed in first and second boxes 2 and 3 of a folding-type mobile phone 1.

The first magnet 2a is fixedly installed in the first box 2, which has a receiver part and a display panel and is arranged such that the polarity thereof is opposite that of the second magnet 3a. Thereby, attractive force is generated between the first and second magnets 2a and 3a.

The second magnet 3a is fixedly installed in the second box 3, which has a transmitter part and manipulation keys. The second magnet 3a is arranged such that the polarity thereof is opposite that of the first magnet 2a. Thereby, attractive force is generated between the first and second magnets 2a and 3a.

The coil spring 5 is installed in a hinge part 4, which is situated at the junction between the first and second boxes 2 and 3, and functions to elastically bias the first and second boxes 2 and 3.

In this case, the elastic force of the coil spring 5 is smaller than the attractive force between the first and second magnets 2a and 3a. Thus, when the first and second magnets 2a and 3a are attached to each other, the mobile phone 1 is kept closed.

The button 12 is an actuating means for opening and closing the mobile phone 1, and is pressed by a user to move the second magnet 3a, thus separating the first and second magnets 2a and 3a from each other. When the first and second magnets 2a and 3a are separated from each other by the button 12, the first box 2 is rotated relative to the second box 3 and is thus opened by the elastic force of the coil spring 5.

However, the conventional opening and closing apparatus for mobile phones, constructed as described above, is problematic in that the second magnet 3a moves in a sliding manner to separate the first and second magnets 2a and 3a from each other, so that a larger installation space is required in consideration of the moving distance of the second magnet 3a and the moving distance of the button 12.

Further, the conventional opening and closing apparatus is problematic in that the magnetic force of the permanent magnets affects the internal parts of the mobile phone, thus deteriorating call quality, and causing the opening and closing apparatus to malfunction.

### SUMMARY OF THE INVENTION

The present invention has been made in an effort to provide an opening and closing apparatus for mobile phones, which uses an electromagnet the polarity of which is changed by external electricity, thus automatically opening and closing a folding-type mobile phone, and which is constructed so that a permanent magnet is installed in the electromagnet, thus minimizing the leakage of the magnetic force of the permanent magnet, and enhancing the reliability of the apparatus.

In an opening and closing apparatus for mobile phones according to an embodiment of the present invention, an electromagnet is installed at a predetermined position in a main body, with a permanent magnet provided in the electromagnet. A metal piece is installed at a predetermined position in a display body, which is foldably coupled to the main body, and generates attractive force between the metal piece and the permanent magnet of the electromagnet. The electromagnet generates magnetic force to offset the attractive force between the permanent magnet and the metal piece, when external electricity is applied to the electromagnet.

The opening and closing apparatus further includes a coil spring elastically biasing the display body to open the display body when external electricity is applied to the electromagnet.

The electromagnet includes a coil generating magnetic force using external electricity, a core around which the coil is wound, a permanent magnet mounted to an upper portion of the core, and a housing accommodating the coil, the core, and the permanent magnet therein.

Each of the core and the housing is made of a magnetic material, such as metal.

In an opening and closing apparatus for mobile phones according to another embodiment of the present invention, an electromagnet is installed at a predetermined position in a main body in such a way as to be secured to the main body. A permanent magnet is installed at a predetermined position in a display body which is foldably coupled to the main body, and generates attractive force between the permanent magnet and the electromagnet when external electricity is not applied to the permanent magnet. The electromagnet has the same polarity as the permanent magnet so that repulsive force between the electromagnet and the permanent magnet is generated when external electricity is applied to the electromagnet.

The opening and closing apparatus further includes a coil spring elastically biasing the display body to open the display body when external electricity is applied to the electromagnet.

The electromagnet includes a coil generating magnetic force using external electricity, a core around which the coil is wound, and a housing accommodating the coil and the core therein.

Each of the core and the housing is made of a magnetic material, such as metal.

The opening and closing apparatus further includes a yoke for concentrating the magnetic force of the permanent magnet on the electromagnet, the yoke being made of a magnetic material, such as metal.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a schematic sectional view showing a folding-type mobile phone equipped with an opening and closing apparatus, according to the present invention;

FIGS. 2 and 3 are schematic sectional views showing an electromagnet, according to an embodiment of the present invention;

FIG. 4 is a schematic sectional view showing an electromagnet, according to another embodiment of the present invention; and

FIG. 5 is a schematic sectional view showing a conventional opening and closing apparatus for mobile phones.

### DESCRIPTION OF THE PREFERRED EMBODIMENTS

Hereinafter, an opening and closing apparatus for mobile phones according to the preferred embodiments of the present invention will be described in detail with reference to the accompanying drawings.

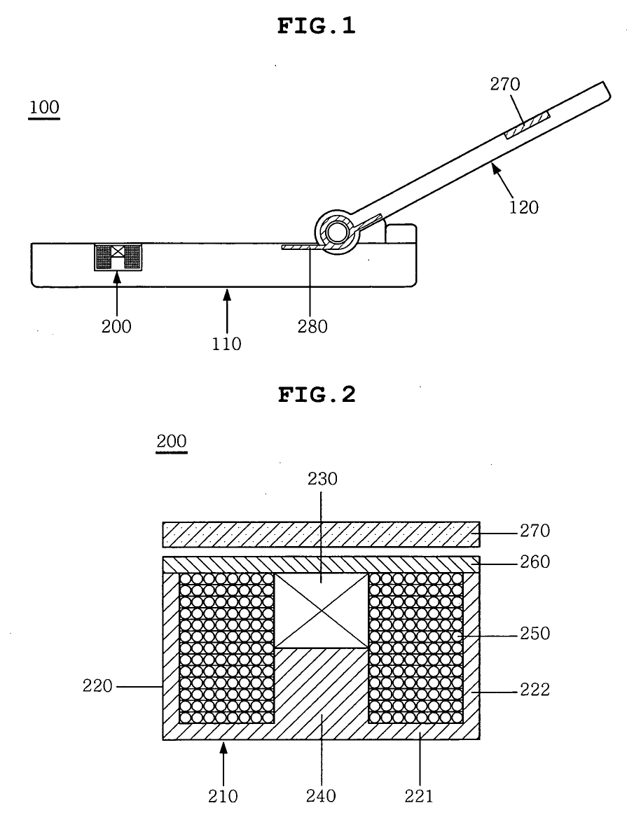

As shown in FIG. 1, an opening and closing apparatus 200 for a mobile phone 100, according to the present invention, includes an electromagnet 210, a metal piece 270, and a coil spring 280, and is installed in a main body 110 and a display body 120.

Here, the main body 110 and the display body 120 of the mobile phone 100 are coupled to each other in such a way as to fold around a hinge. The coil spring 280 is installed in the hinged portion, and the mobile phone 100 is opened by the torsional elastic force of the coil spring 280.

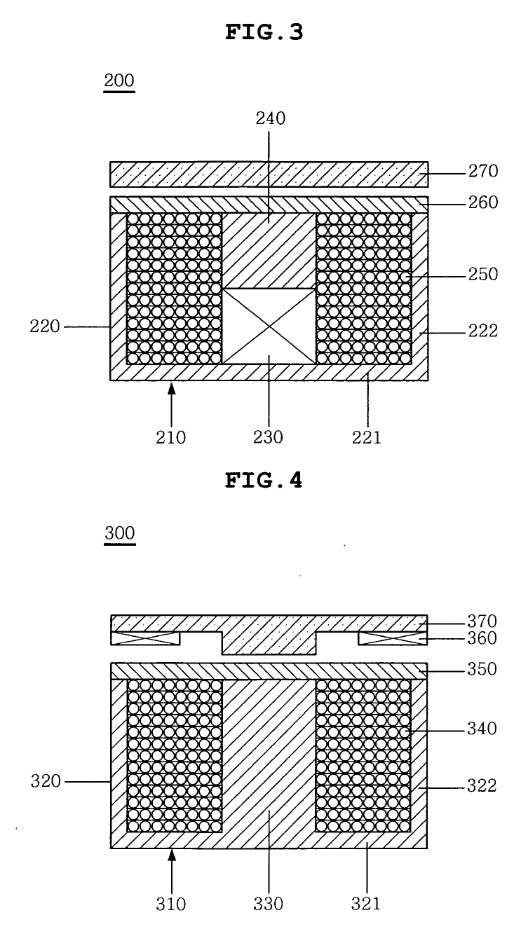

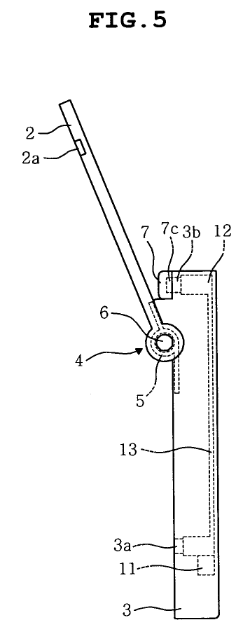

As shown in FIGS. 2 and 3, the electromagnet 210 of the opening and closing apparatus 200 for the mobile phone 100 according to an embodiment of the present invention includes a housing 220, a permanent magnet 230, a core 240, a coil 250, and a lid 260.

The housing 220 functions to accommodate parts constituting the electromagnet 210 therein, and is made of a magnetic material, such as metal, so as to concentrate the magnetic force of the permanent magnet 230 and the magnetic force of the coil 250. An opening is provided in the upper portion of the housing 220, so that the lid 260 is mounted to the opening.

This housing 220 includes a flat panel part 221 and an edge part 222, which is integrally provided on the edge of the flat panel part 221.

A core 240 protrudes integrally from the central portion of the flat panel part 221, with the coil 250 being wound around the core 240. The flat panel part 221 prevents the magnetic force of the permanent magnet 230 and coil 250 from leaking downwards.

The edge part 222 extends upwards from the edge of the flat panel part 221, and surrounds the circumference of the coil 250, which is wound around the core 240 and the permanent magnet 230, thus preventing the magnetic force of the coil 250 and the permanent magnet 230 from leaking in a radial direction, in addition to concentrating the magnetic force of the coil 250 and the permanent magnet 230 on the metal piece 270.

The permanent magnet 230 serves to generate force that attracts the metal piece 270. In order to keep the display body 120 of the mobile phone 100 closed, attractive force, which is larger than the elastic force of the coil spring 280, is generated between the permanent magnet 230 and the metal piece 270. According to this embodiment, the permanent magnet 230 is fixedly installed in the electromagnet 210, that is, in the housing 220.

The core 240 is provided in the housing 220 in such a way as to protrude from the central portion of the flat panel part 221, so that the coil 250 is wound on the circumference of the core 240. Further, according to this embodiment, the core 240 is slightly lower than the edge part 222 in consideration of the height of the permanent magnet 230. Thereby, the permanent magnet 230 is attached to the upper portion of the core 240.

According to this embodiment, the core 240 is made of the same material as the housing 220, that is, a metallic magnetic material, and is integrated with the flat panel part 221 into a single structure. However, the core 240 may be manufactured separately from the flat panel part 221, and thereafter may be attached to the flat panel part 221. Further, according to this embodiment, the permanent magnet 230 is attached to the upper portion of the core 240. However, unlike this embodiment, as shown in FIG. 3, the permanent magnet 230 may be attached to the lower portion of the core 240 in such a way as to be secured to the flat panel part 221.

Since the core 240 is made of a metallic magnetic material, the magnetic force of the coil 250 which is wound around the core 240 and the permanent magnet 230 which is mounted on the upper portion of the core 240 can be concentrated on the metal piece 270.

The coil 250 functions to generate magnetic force when external electricity is applied to the coil 250, thus offsetting the attractive force between the metal piece 270 and the permanent magnet 230. The coil 250 is positioned in the housing 220, and is wound around the core 240 and the permanent magnet 230 several times.

When external electricity is applied to the coil 250, the coil 250 generates magnetic force so as to offset the attractive force between the metal piece 270 and the permanent magnet 230. According to this embodiment, the coil 250 generates magnetic force which completely negates the magnetic force of the permanent magnet 230.

The lid 260 closes the opening of the housing 220, thus preventing the parts constituting the electromagnet 210 from being dislodged from the housing 220.

The operation of the opening and closing apparatus 200 for the mobile phone 100, constructed as described above, will be described below with reference to FIGS. 1 to 3.

First, when the display body 120 is closed, electricity is not applied to the coil 250 of the electromagnet 210, and attractive force is generated between the permanent magnet 230 and the metal piece 270 by the magnetic force of the permanent magnet 230. At this time, since the intensity of the attractive force between the permanent magnet 230 and the metal piece 270 is larger than that of the elastic force of the coil spring 280, the display body 120 maintains a closed state.

Next, when external electricity is applied to the electromagnet 210 so as to open the display body 120, magnetic force is generated by the coil 250 of the electromagnet 210 so as to offset the attractive force between the permanent magnet 230 and the metal piece 270. Thereby, the attractive force between the permanent magnet 230 and the metal piece 270 approximates 0. As the intensity of the attractive force between the permanent magnet 230 and the metal piece 270 is reduced, the display body 120 is rotated relative to the main body 110 to be opened by the elastic force of the coil spring 280.

The opening and closing apparatus 200 is constructed so that the permanent magnet 230 is installed in the electromagnet 210, and the metal piece 270 is used as the target for the electromagnet 210. However, unlike this construction, a permanent magnet may be used as the target for the electromagnet 210. Corresponding thereto, an opening and closing apparatus 300 for the mobile phone 100, according to another embodiment of the present invention, will be described with reference to FIG. 4. For brevity of description, the parts of the second embodiment that are equal to those of the first embodiment will not be described herein.

As shown in FIG. 4, the opening and closing apparatus 300 for the mobile phone 100, according to another embodiment of the invention, includes an electromagnet 310, a permanent magnet 360, a yoke 370, and a coil spring 380. The electromagnet 310 is provided with a housing 320, a core 330, a coil 340, and a lid 350.

The housing 320 functions to accommodate parts constituting the electromagnet 310 therein, and is made of a magnetic material, such as metal, so as to concentrate the magnetic force of the permanent magnet 360 and the magnetic force of the coil 340. An opening is provided in the upper portion of the housing 320, so that the lid 350 is mounted to the opening.

In this case, the housing 320 includes a flat panel part 321, and an edge part 322 which is integrally provided on the edge of the flat panel part 321.

A core 330 protrudes integrally from the central portion of the flat panel part 321, and the coil 340 is wound around the core 330. The flat panel part 221 prevents the magnetic force of the coil 340 from leaking downwards.

The edge part 322 extends upwards from the edge of the flat panel part 321, and surrounds the circumference of the coil 340, which is wound around the core 330, thus preventing the magnetic force of the coil 340 from leaking in a radial direction, in addition to concentrating the magnetic force of the coil 340 on the permanent magnet 360.

The core 330 is provided in the housing 320 in such a way as to protrude from the central portion of the flat panel part 321, so that the coil 340 is wound on the circumference of the core 330. Further, according to this embodiment, the height of the core 330 is the same as that of the edge part 322.

According to this embodiment, the core 330 is made of the same material as the housing 321, that is, a metallic magnetic material, and is integrated with the flat panel part 321 into a single structure. However, the core 330 may be manufactured separately, and thereafter may be attached to the flat panel part 321.

Since the core 330 is made of a metallic magnetic material, the magnetic force of the coil 340 wound around the core 330 can be concentrated on the permanent magnet 360.

The coil 340 functions to generate magnetic force when external electricity is applied to the coil 340, thus offsetting the attractive force between the core 330 and the permanent magnet 360. The coil 340 is positioned in the housing 320, and is wound around the core 330 several times. In an embodiment, the coil 340 has the same polarity as the permanent magnet 360, so as to generate repulsive force between the coil 340 and the permanent magnet 360 when external electricity is applied to the coil 340.

The lid 350 closes the opening of the housing 320, thus preventing parts constituting the electromagnet 310 from being dislodged from the housing 320.

According to this embodiment, the permanent magnet 360 is used as the object corresponding to the electromagnet 310. The permanent magnet 360 is secured to the yoke 370. In an embodiment, the yoke 370 is made of a magnetic material, such as metal, so as to concentrate the magnetic force of the permanent magnet 360 on the electromagnet 310.

The operation of the opening and closing apparatus 300 for the mobile phone 100 constructed as described above will be described with reference to FIGS. 1 and 4.

First, when the display body 120 is closed, electricity is not applied to the coil 340 of the electromagnet 310. Attractive force is generated between the permanent magnet 360 and the electromagnet 310 by the magnetic force of the permanent magnet 360. At this time, since the attractive force between the permanent magnet 360 and the electromagnet 310 is larger than the elastic force of the coil spring 380, the display body 120 maintains a closed state.

Next, when external electricity is applied to the electromagnet 310 so as to open the display body 120, magnetic force is generated by the coil 340 of the electromagnet 310 so that the polarity of the electromagnet 310 is the same as that of the permanent magnet 360. Thereby, the attractive force between the permanent magnet 360 and the electromagnet 310 is offset. When repulsive force is generated between the permanent magnet 360 and the electromagnet 310, the display body 120 is rotated relative to the main body 110 by the elastic force of the coil spring 380, and thus opened.

Although an opening and closing apparatus according to the preferred embodiment of the present invention has been described applied to a mobile phone, those skilled in the art will appreciate that the opening and closing apparatus may be applied to all devices which may be opened or closed, for example, notebook computers, mobile phones, PDAs, and portable games. As such, the present invention may be applied to various fields, without being limited to a specific field. Further, those skilled in the art will appreciate that various modifications, additions and substitutions are possible, without departing from the scope and spirit of the invention as disclosed in the accompanying claims.

As described above, the present invention provides an opening and closing apparatus for mobile phones, which uses an electromagnet the polarity of which is changed by external electricity, thus automatically opening and closing a folding-type mobile phone, and which is constructed so that a permanent magnet is installed in the electromagnet, thus minimizing the leakage of magnetic force of the permanent magnet, therefore enhancing the reliability of the apparatus.

What is claimed is:

1. An opening and closing apparatus for mobile phones, comprising:
an electromagnet installed at a predetermined position in a main body, with a permanent magnet provided in the electromagnet; and
a metal piece installed at a predetermined position in a display body, which is foldably coupled to the main body, and generating attractive force between the metal piece and the permanent magnet of the electromagnet, wherein
the electromagnet generates magnetic force to offset the attractive force between the permanent magnet and the metal piece, when external electricity is applied to the electromagnet.

2. The opening and closing apparatus as set forth in claim 1, further comprising:
a coil spring elastically biasing the display body to open the display body when external electricity is applied to the electromagnet.

3. The opening and closing apparatus as set forth in claim 1, wherein the electromagnet comprises:
a coil generating magnetic force using external electricity;
a core around which the coil is wound;
a permanent magnet mounted to an upper portion of the core; and
a housing accommodating the coil, the core, and the permanent magnet therein.

4. The opening and closing apparatus as set forth in claim 3, wherein each of the core and the housing is made of a magnetic material, such as metal.

5. An opening and closing apparatus for mobile phones, comprising:
an electromagnet installed at a predetermined position in a main body in such a way as to be secured to the main body; and
a permanent magnet installed at a predetermined position in a display body which is foldably coupled to the main body, and generating attractive force between the permanent magnet and the electromagnet when external electricity is not applied to the permanent magnet, wherein
the electromagnet has the same polarity as the permanent magnet so that repulsive force between the electromagnet and the permanent magnet is generated when external electricity is applied to the electromagnet.

6. The opening and closing apparatus as set forth in claim 5, further comprising:
a coil spring elastically biasing the display body to open the display body when external electricity is applied to the electromagnet.

7. The opening and closing apparatus as set forth in claim 5, wherein the electromagnet comprises:
a coil, generating magnetic force using external electricity;
a core, around which the coil is wound; and
a housing, accommodating the coil and the core therein.

8. The opening and closing apparatus as set forth in claim 7, wherein each of the core and the housing is made of a magnetic material, such as metal.

9. The opening and closing apparatus as set forth in claim 5, further comprising:
a yoke for concentrating the magnetic force of the permanent magnet on the electromagnet, the yoke being made of a magnetic material, such as metal.
